(19) United States
(12) Patent Application Publication
(10) Pub. No.: US 2016/0027135 A1
(43) Pub. Date: Jan. 28, 2016

(54) REPRESENTING LEGAL INSTRUMENTS AS A SOFTWARE FRAMEWORK

(71) Applicants: Jeannette Eicks, (US); Oliver Goodenough, Woodstock, VT (US)

(72) Inventors: Jeannette Eicks, Brookfield, VT (US); Oliver Goodenough, Woodstock, VT (US)

(21) Appl. No.: 14/806,103

(22) Filed: Jul. 22, 2015

Related U.S. Application Data
(60) Provisional application No. 62/027,360, filed on Jul. 22, 2014.

(51) Int. Cl. G06Q 50/18; G06Q 10/00

(52) U.S. Cl. CPC G06Q 50/18; G06Q 10/00

(57) ABSTRACT

Systems and methods for representing legal obligations, conditions, and other contractual specifications as a software framework are described. Systems and methods may include receiving initiation input; accessing an initial node including one or more logical structures and links to one or more tables of states and values; requesting initial input; receiving initial input; accessing at least one of the one or more tables of states and values to determine if a calculation is required; and performing a calculation based on the initial input from the user to determine an initial value or receiving an initial value from the at least one of the one or more tables of states and values. Subsequent nodes may be accessed until a final node is reached. A software framework may be compiled based on the calculations in each accessed node of the logical framework.

### CROSS-REFERENCE TO RELATED APPLICATIONS

This application claims priority to U.S. Provisional Patent Application No. 62/027,360, filed Jul. 22, 2014; the contents of which are hereby incorporated by reference in their entirety.

### FIELD OF THE INVENTION

The present invention relates to systems and methods for representing legal instruments, including the legal specifications, obligations, and conditions specified by such instruments, as software, and, more specifically, to systems and methods for representing legal instruments, and the legal specifications, obligations, and conditions specified by such instruments, as a software framework.

### BACKGROUND OF THE INVENTION

Drafting of legal instruments—and the representations of the legal specifications, obligations and conditions that they include—is a time and labor intensive process with opportunities to introduce error and unnecessary complexity. While some boilerplate language may be reused in documents, when using the current bespoke method of generating representation of legal instruments in document form the primary terms must be drafted each time by a lawyer or other professional to set forth the conditions of a specific series of legal instrument specifications. Intensive labor is required by individuals to create these documents. The maintenance of these legal documents often mandates involvement of a legal professional for interpretation, clarification or evaluation. This processes of forming, documenting, performing and administering legal instruments are often opaque to the consumer, time consuming and expensive. Furthermore, due to differences in language and style of writing, ambiguity may be introduced into these documents.

Prior attempts at legal instrument automation have focused on natural language processing, physical document creation, and related systems rather than using the logical structures native to computing languages and programming to describe and record legal instruments as software. The degree of precision required to define future obligations and outcomes strains the boundaries and capacities of natural language and frequently results in disputed ambiguity. These systems lack the precision gained by originating and maintaining legal instruments as code within software and are not effective throughout the lifecycle of the agreement.

Currently, there are no similar systems or methods for creating software to replace a written legal instrument, including the specifications, obligations and conditions such instruments often contain, or of scaling drafting, maintaining and monitoring of these legal specifications on a large scale.

Needs exist for improved systems and methods for creating legal instruments.

### SUMMARY OF THE INVENTION

Embodiments of the present invention solve many of the problems and/or overcome many of the drawbacks and disadvantages of the prior art by providing systems and methods for originating and maintaining legal instruments as software rather than as a written legal document originated and maintained in natural language.

Systems and methods as described herein may express logical conditions of legal instruments through computer software. The architecture of such a process may deliver the utility and effectiveness of that process. Certain embodiments may include novel and effective methods for structuring such a process.

Embodiments may include systems and methods for representing legal obligations, conditions, and other specifications as software. Obligations may be actions that must be accomplished by the parties to the agreement. Conditions may be events exterior to the agreement. Other legal specifications may be either actions, changes of legal status or rights, or other events. The systems and methods may include accessing a software development initiation module. The software may guide a legal instrument developer through a logical framework of legal specification and/or offer customization possibilities through the use of logical structures. Systems and methods may include accessing a software development initiation module; receiving initiation input; accessing an initial node including one or more logical structures and links to one or more tables of states and values; requesting initial input; receiving initial input; accessing at least one of the one or more tables of states and values to determine if a calculation is required; and performing a calculation based on the initial input from the user to determine an initial value or receiving an initial value from the at least one of the one or more tables of states and values. Subsequent nodes may be accessed until a final node is reached. A software framework may be compiled based on the calculations in each accessed node of the logical framework.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows an exemplary system for representing legal instruments, including the obligations, conditions and other specifications which they contain, as software.

FIG. 2 shows an exemplary system for representing legal instruments, including the obligations, conditions and other specifications which they contain, as software.

FIG. 3 shows an exemplary flow diagram for representing legal instruments, including the obligations, conditions and other specifications which they contain, as software.

FIG. 4 shows an exemplary framework diagram for representing logical conditions, internal and external data and the tables of states and values as together they represent legal instruments, including the obligations, conditions and other specifications which they contain, as software.

### DETAILED DESCRIPTION OF THE PREFERRED EMBODIMENTS

Systems and methods are described for using various tools and procedures for representing legal instruments, including the obligations, conditions and other specifications which they contain, in a software framework. Legal instruments may include, but are not limited to, contracts and any document that can be a formal record of a legally enforceable or legally recognizable act, process, duty, obligation, or right. In certain embodiments, the tools and procedures may be used in conjunction with the creation of one or more representations of legal instruments, including the obligations, conditions and other specifications which they contain, as software. The examples described herein relate to representing legal instruments, including the obligations, conditions and other specifications which they contain, as software for illustrative purposes only. The systems and methods described herein may be used for many different industries and purposes, including any industry where formal logic structures are used to create documents. In particular, the systems and methods may be used for any industry or purpose where repeated document drafting is needed. For multi-step processes or methods, steps may be performed by one or more different parties, servers, processors, etc.

A system may be initiated. Initiation may be by any process known in the art. Initiation may initialize the software system and prepare the software system to accept inputs from a user/developer.

After initiation, a user/developer of legal instrument software may follow prompts provided to select elements of a legal instrument, including the obligations, conditions and other specifications which it contains, through a tree hierarchy or other logical structure and enter information when and where appropriate. Prompts and/or a tree hierarchy or other logical structure may be provided by any process known in the art. Calculations may be made at each node of the tree hierarchy or other logical structure, if necessary. Upon completion, the software framework and the entered information may be compiled into a legal instrument that reflects the input of the user. Compiling may be provided by any compilation process known in the art. The user and/or parties to the legal instrument may use the software throughout the life of the legal instrument to monitor obligations, query obligations, query conditions, model environmental changes, view a visual representation of the instrument and the obligations, conditions and other specifications which it contains, and perform other similar actions.

The systems and methods may use if/then statements or other logical structures to represent the requirements of a legal instrument, such as a contract, as software. Other logical structures may include, but are not limited to, if/then, if else if, and, or, negation, implication, converse, contrapositive, negated implication, equivalent, etc. The logical structure may hold a sequence of events or an array for comparison. For illustration, the description herein refers to if/then statements as one possible example of a logical structure. Certain embodiments may eliminate the need for redundant calculations by only making calculations as required by an if/then tree hierarchy or other logical structure.

Although not required, the systems and methods are described in the general context of computer program instructions executed by one or more computing devices that can take the form of a traditional server/desktop/laptop; mobile device such as a smartphone or tablet; or embedded in hardware. Computing devices typically include one or more processors coupled to data storage for computer program modules and data. Key technologies include, but are not limited to, the multi-industry standards of Microsoft and Linux/Unix based Operating Systems; databases such as SQL Server, Oracle, NOSQL, and DB2; Business Analytic/Intelligence tools such as SPSS, Cognos, SAS, etc.; development tools such as Java, GWT, NODE, .NET Framework (VB.NET, ASP.NET, AJAX.NET, etc.); and other e-Commerce tools, computer languages, and development tools. Such program modules generally include computer program instructions such as routines, programs, objects, components, firmware, etc., for execution by the one or more processors to perform particular tasks, utilize data, data structures, and/or implement particular abstract data types. While the systems, methods, and apparatus are described in the foregoing context, acts and operations described hereinafter may also be implemented in hardware, with or without accompanying software, and/or embedded in physical objects.

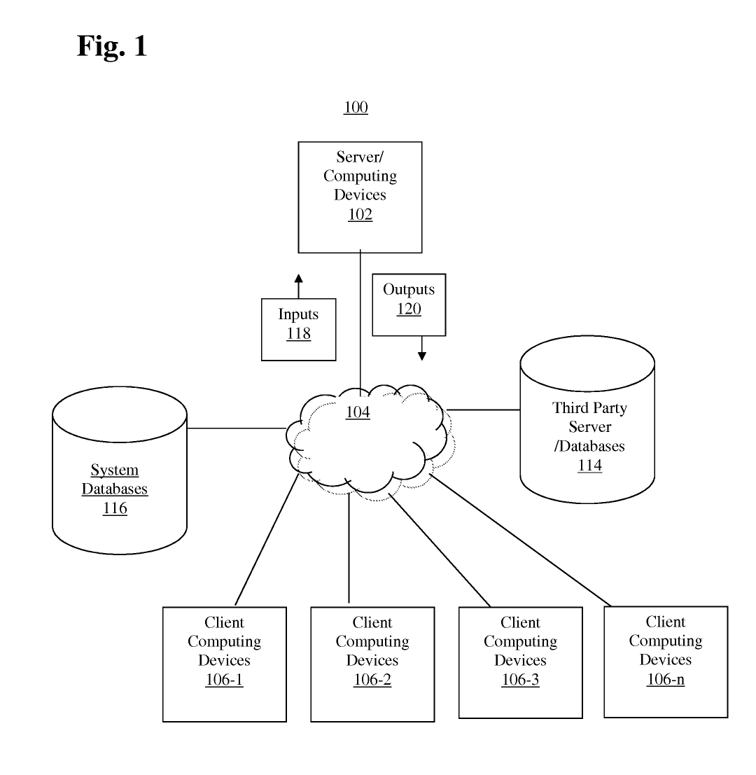

FIG. 1 shows an exemplary system 100 for representing legal instruments, including the obligations, conditions and other specifications which they contain, as software according to one embodiment of the framework. In this exemplary implementation, system 100 may include one or more servers/computing devices 102 (e.g., server 1, server 2, . . . , server n) operatively coupled over network 104 to one or more client computing devices 106-1 to 106-n, which may include one or more consumer computing devices, one or more provider computing devices, one or more remote access devices, etc. The one or more servers/computing devices 102 may also be operatively connected, such as over a network, to one or more third party servers/databases 114 (e.g., database 1, database 2, . . . , database n). The one or more servers/computing devices 102 may also be operatively connected, such as over a network, to one or more system databases 116 (e.g., database 1, database 2, . . . , database n). Various devices may be connected to the system, including, but not limited to, client computing devices, consumer computing devices, provider computing devices, remote access devices, etc. This system may receive inputs 118 and outputs 120 from the various computing devices, servers, internal databases and external third party databases.

Server/computing device 102 may represent, for example, any one or more of a server, a general-purpose computing device such as a server, a personal computer (PC), a laptop, a smart phone, a tablet, and/or so on. Networks 104 represent, for example, any combination of the Internet, local area network(s) such as an intranet, wide area network(s), cellular networks, WIFI networks, and/or so on. Such networking environments are commonplace in offices, enterprise-wide computer networks, etc. Client computing devices 106, which may include at least one processor, represent a set of arbitrary computing devices executing application(s) that respectively send data inputs to server/computing device 102 and/or receive data outputs from server/computing device 102. Such computing devices include, for example, one or more of desktop computers, laptops, mobile computing devices (e.g., tablets, smart phones, human wearable device), server computers, and/or so on. In this implementation, the input data comprises, for example, data entry, data uploads, data selection for agreement implementation, and/or so on, for processing with server/computing device 102. In one implementation, the data outputs include, for example, an expression of legal obligations as software, documents, emails, templates, forms, visual dashboards and/or so on. Embodiments of the present invention may also be used for collaborative projects with multiple users logging in and performing various operations on logic components or data components of a legal instrument project from various locations. Without limitation, embodiments of the present invention may be web-based, smart phone-based and/or tablet-based or human wearable device based.

In this exemplary implementation, server/computing device 102 includes at least one processor coupled to a system memory. System memory may include computer program modules and program data.

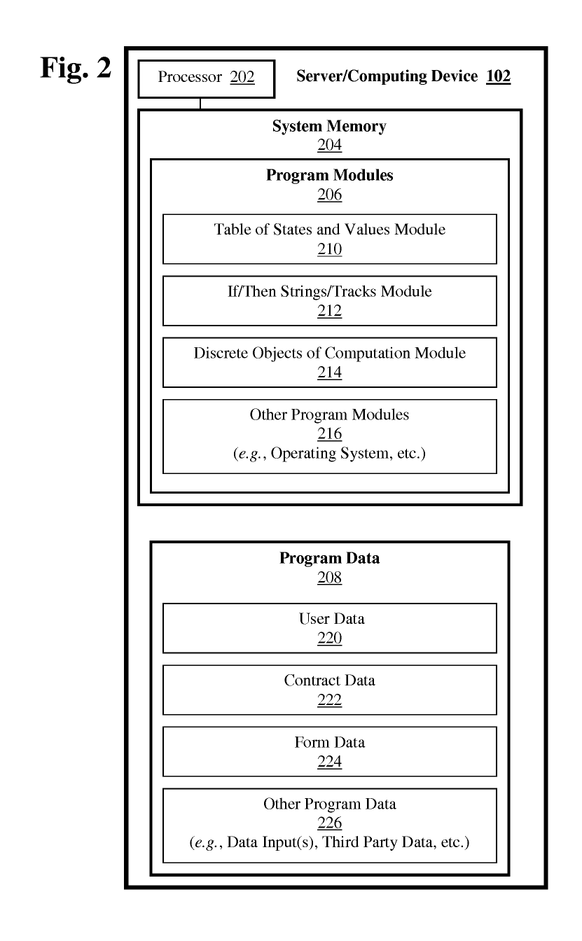

In this exemplary implementation, server/computing device 102 includes at least one processor 202 coupled to a system memory 204, as shown in FIG. 2. System memory 204 may include computer program modules 206 and program data 208. In this implementation program modules 206 may include tables of values and states module 210, if/then string/tracks module 212, discrete objects of computation module 214, and other program modules 216 such as an operating system, device drivers, etc. Each program module 210 through 216 may include a respective set of computer-program instructions executable by processor(s) 202. This is one example of a set of program modules and other numbers and arrangements of program modules are contemplated as a function of the particular arbitrary design and/or architecture of server/computing device 102 and/or system 100 (FIG. 1). Additionally, although shown on a single server/computing device 102, the operations associated with respective computer-program instructions in the program modules 206 could be distributed across multiple computing devices. Program data 208 may include user data 220, contract data 222, form data 224, and other program data 226 such as data input(s), third party data, and/or others.

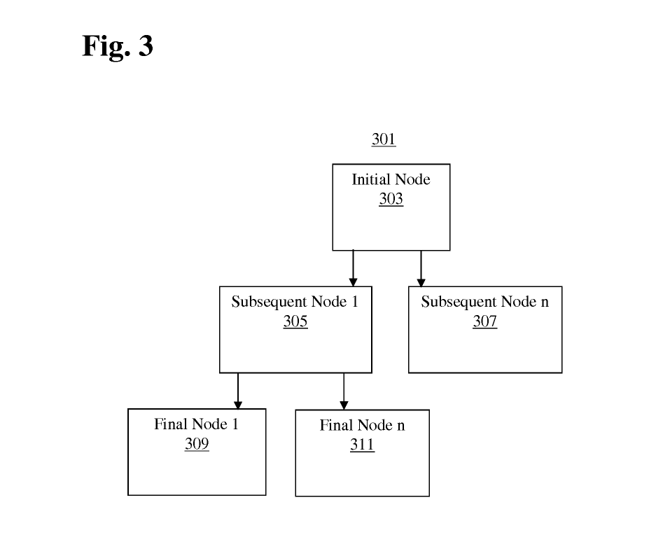

FIG. 3 is an overview of an exemplary system 301 according to one embodiment. A computerized method may represent legal instruments and the obligations, conditions and other specifications which they may contain, as a framework for software. A user, such as a legal obligations software developer, may access and/or log into a system. The system may access a software development initiation module based on the instrument type selection of the user. The framework may allow a user to select from one or more modules/logical structures to build the obligations and conditions software. The modules/logical structures may be built by the user or may be adopted from other users. The framework may come with predetermined modules/logical structures. The developer may provide one or more items of initiation input/information to allow the system to initiate. For example, the user may select a particular type of software for development, such as a type of contract, a deed, or a will. The initiation information may include obligation type, user and/or party information, dates, values, etc.

Based on the initiation information, the system may access an initial node 303 of a tree hierarchy or other logical framework within a software framework. The accessing of the initial node 303 may be linked to one or more items of the initiation information, or by another input from the user. Access may be provided by methods known in the art. The initial node 303 may include one or more if/then statements or other logical structures. The initial node 303 may provide opportunities to establish connections between data and logical functions with one or more persistent links to tables of states and values. The connections may be data calls via a data connection or an internal table or reference stored in memory. The if/then statements or other logical structures, connections between data and logical functions and tables of states and values are described in more detail herein.

The initial node 303, and in certain embodiments sole node, may be associated with at least one initial choice provided to the legal instrument software developer. In response to the initial choice, the system may receive initial input from the developer. The initial input may be an “if” portion of an if/then statement from the developer followed by a “then” portion of the statement. In certain embodiments, the initial input may be the formation of a connection between data and a logical function. The developer may provide a response as an initial input request.

The system may then access the tables of states and values to determine if a calculation is required. If a value is already stored in a table, then no calculation is required. A check based on an expiration date-time may be made to determine if the stored value from a previous entry or calculation is still valid based on current conditions. If the value is still valid, no calculation may be performed and an initial value may be returned to the node.

If no value or no valid value is in one of the tables, then the system may perform a calculation based on the initial input from the user to determine an initial value. The calculation may be determined by the initial node. The initial node may include information regarding the inputs, processing, and outputs of the calculation. The calculation may result in an initial value. If necessary, the initial value may determine how to proceed through the tree hierarchy or other logical framework to a subsequent node. If no subsequent nodes are present, the tree hierarchy or other logical framework may terminate.

If appropriate, the system may then access a subsequent node 305, 307 in response to the initial value. The subsequent node 305, 307 may include one or more if/then statements or other logical structures and one or more links to tables of states and values.

The subsequent node may be associated with at least one subsequent input from the developer. The input may be in response to providing at least one choice to the developer regarding the subsequent node. The initial input may be an “if” portion of the if/then statement from the developer followed by the ‘then’ portion of the statement. Alternatively, the initial developer input may be the formation of a connection between data and a logical function. The developer may provide a response as an initial input request. The system may then access tables of states and values to determine if a calculation is required. If a value is already stored in a table, then no calculation is required. A check based on an expiration date-time may be made to determine if the stored value from a previous entry or calculation is still valid based on current conditions. If the value is still valid, no calculation may be performed and the value may be returned to the node.

If no value or no valid value is in one of the tables, then the system may perform a calculation based on the subsequent input from the user to determine a subsequent value. The calculation may be determined by the subsequent node. The subsequent node may include information regarding the inputs, processing, and outputs of the calculation. The calculation may result in a subsequent value. The subsequent value may determine how to proceed through the tree hierarchy or other logical framework, such as to another subsequent and/or final node.

If necessary, the system may repeat these steps to follow a tree hierarchy or other logical framework until there are no subsequent nodes in the tree hierarchy or other logical framework. A final node 309, 311 may be the end of a tree hierarchy or other logical framework. At any point in the process, an updated value may require moving from one path through the tree hierarchy or other logical framework to another, such as from one string/track to another string/track. Conditional logic may provide for state changes that allow movement from one path to another. The software may search for changes to any specific value, and may run another set of instructions based on the updated value.

Once the path through the tree hierarchy is complete, the system may compile a legal instrument based on the calculations in each accessed node of the tree hierarchy or other logical framework. The result may be a legal instrument, which in turn may be a contract, where the legal instrument is determined by the string/track through the tree hierarchy or other logical framework.

Certain embodiments may include calendaring, reporting, and/or reminder functions. Methods for calendaring, reporting, and/or reminder functions may be known in the art. For example, the compiled legal instrument may populate calendars or may interact with one or more programs that provide calendar functions. In certain embodiments the compiled software may send electronic notifications or cause other programs to send notification to designated individuals so that they can be forewarned to look for correspondence or begin follow-up procedures or attend to compliance requirements.

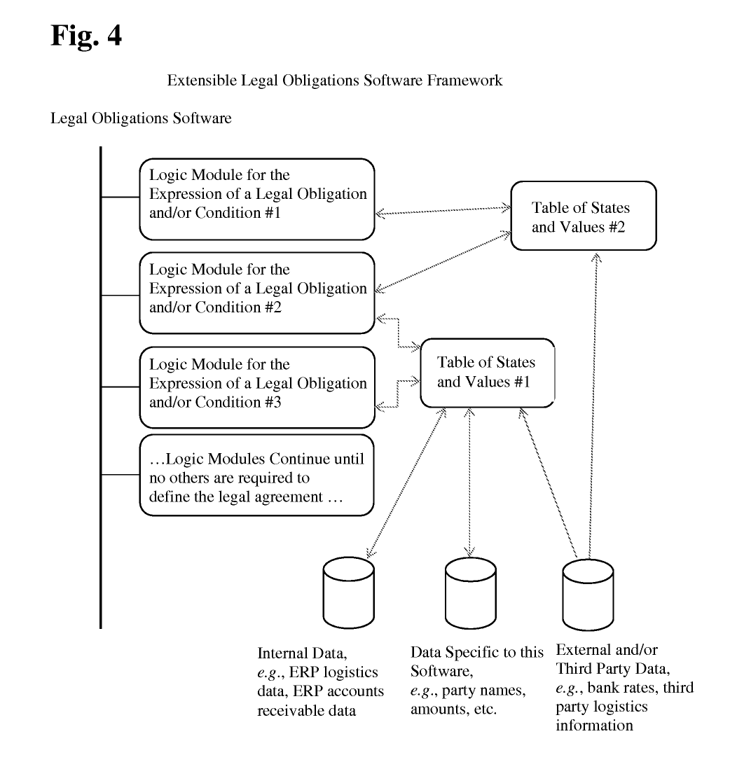

FIG. 4 shows an exemplary framework diagram for representing logical conditions, internal and external data and the tables of states and values as together they represent legal instruments, including the obligations, conditions and other specifications which they contain, as software. Each logical module or structure may address some aspect of the legal instrument, be an obligation or condition of a contract or other specific legal requirement. The logic modules may have access to various tables of states and values. The access can be read only or read and write access, depending on who controls the data and how it is made available to the software. Modules may be added until the legal instrument is completely specified. Each of the logic modules may interact with one or more tables of states and values. Each table of states and values may interact with one or more databases. Databases may include internal data, data specific to particular software, and/or external and/or third party data.

Redundant calculations may be determined and/or avoided by lookups in the tables of states and values. Each node may have separate calculations. A lookup may determine if a calculation is already completed for a particular node. The entire string/track does not need to be recalculated at each step if there are states and values stored in a table.

Certain embodiments may be used as a model to predict outcomes. For example, a user may query what happens if an action occurs. For example, the user may query what happens if a contracting party misses two payments. The system may access the appropriate nodes in the system, run a calculation, and determine the result, for example, default, change in rates, etc.

Certain embodiments may be used to adapt existing legal instruments into a software framework. An existing legal instrument may be used as initiation input, and may provide subsequent information to perform calculations at one or more nodes. Such embodiments may allow for reverse engineering and/or translation of existing legal instruments into a software framework. This may allow for analysis of existing legal instruments via the software framework.

Certain embodiments may provide systems and methods for representing legal instruments in a software framework. Certain components may include (i) one or more logical structures, such as if/then strings/tracks, (ii) logical framework for legal obligations, (iii) one or more tables of states and values, (iv) external queries of values and (v) discrete objects of computation. External queries may perform a real-time or near real-time polling of data external to the agreement, such as of third party data. A discrete object of computation may be, for example, a spawned child function that keeps track of some condition that is reported by an external party and is relied upon by the legal instrument like collateral or escrow. This may also be a function that calculates penalties to a loan based on other contractual factors and external data. These discrete objects of computation could also be reused by the legal instrument creator in other legal instruments. Various forms of discrete objects of computation may be developed and used for various purposes.

Certain embodiments may include one or more logical structures, such as if/then strings/tracks. These components may connect nodes in an order. The order may be determined by information entered by the developer. These orders are known as “strings” or “tracks”. In certain embodiments, it may be possible to change from one string/track to another based on conclusions of object computation.

Certain embodiments may include one or more tables of states and values. Tables of states and values may be used in the automation of legal instruments.

States may be data values at a particular instance that gives rise to specific instructions or functions. States may be binary or multi-valued. Exemplary states of a contract, a form of legal instrument, may include, but are not limited to:
validity of the contract/execution;
in compliance/out of compliance;
reasons or responsibility (where important);
addresses on strings/tracks within the process, where the addresses may be locations of information in time and/or space; and
existence/nonexistence of elements in the outside world (e.g., collateral, guarantors, quality rating), where the outside world may be data values external to the agreement, such as third party data.

Values may be any data that may be measured, counted, or compared to other data in a way that can be used to logically determine a state. Values may be items with traditional quantification. Exemplary values may include, but are not limited to:
time;
monetary amounts;
rates;
quantities; and
rankings and/or ratings.

Rates and values can be current variables or preserved benchmarks. Current values may be real-time data obtained from external systems or static values internal to the program at a point in time. Preserved benchmarks may be values that are established in the legal instrument that may cause a change of state. Preserved benchmarks may be static values.

Certain embodiments may include one or more logic modules and/or strings of logic modules. Logic modules may require/manage/perform/audit a small piece of the agreement. Logic modules may be a section of computer code that has been reduced to having responsibility for a single aspect of the agreement. These one or more logic modules and/or strings of logic modules may perform one or more of the following:
query the outside world;
query the inside world (tables of states and values);
do a state calculation;
do a value calculation;
make a comparison of states and values to benchmarks;
change a state or value;
change a benchmark;
require an outside notice, such as, but not limited to where a third party provides data that changes a state;
monitor the completion of the outside notice;
require an outside action;
monitor the completion of the outside action;
declare an error state;
specify the next step on the string to move to (direct link or address/state directed);
start the program (on switch);
end/suspend the program (off switch); and
combine one or more actions into a series.

Certain embodiments may also include additional automation of the workflow. In certain embodiments, the outside interaction may prompt or depend on a human person or only non-human connections. Additional automation may include, but is not limited to:
automating the outside query (e.g., “what is LIBOR”);
automating the outside notice (e.g., “a party is out of compliance”);
automating the outside action (e.g., “transfer $X to bank account Y”) and;
creating the ability to query the states and values by other programs to perform analytics, accounting, etc.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A computerized method comprising the steps of:
receiving initiation input from a user regarding a type of software for development, wherein the software represents a legal instrument as a logical framework;
accessing an initial node of the logical framework based on the initiation input, wherein the initial node comprises one or more logical structures and links to one or more tables of states and values;
requesting at least one initial input to initiate the initial node;
receiving initial input from the user in response to the request;
accessing at least one of the one or more tables of states and values to determine if a calculation is required based on the initial input; and
performing, by one or more processors, a calculation based on the initial input from the user to determine an initial value or receiving, by one or more processors, an initial value from the at least one of the one or more tables of states and values.

2. The method of claim 1, further comprising the steps of:
accessing a subsequent node of the logical framework in response to the initial value, wherein the subsequent node comprises one or more logical structures and links to tables of states and values;
providing at least one subsequent choice to the user regarding the subsequent node;
receiving subsequent input from the user in response to the at least one subsequent choice;
accessing tables of states and values to determine if a calculation is required; and
performing a calculation based on the subsequent input from the user to determine a subsequent value or receiving an subsequent value from a table of states and values.

3. The method of claim 2, further comprising the steps of:
repeating the steps from accessing a subsequent node to performing a calculation based on the subsequent input until there are no subsequent nodes in the tree hierarchy; and
compiling a software framework based on the calculations in each accessed node of the logical framework.

4. The method of claim 1, wherein one or more logical structures are if/then statements.

5. The method of claim 1, wherein the states are selected from the group consisting of: validity of a contract, execution of a contract, in compliance, out of compliance, reasons, responsibility, addresses of nodes, existence of elements, nonexistence of elements, and combinations thereof.

6. The method of claim 1, wherein the values are selected from the group consisting of: time, monetary amounts, rates, quantities, rankings, ratings and combinations thereof.

7. The method of claim 1, wherein the legal instrument comprises obligations, conditions and other legal specifications.

8. The method of claim 1, wherein receiving a value from a table of states and values comprises determining an expiration date or time of a stored initial value.

9. The method of claim 1, wherein the initiation input is a type of document.

10. The method of claim 1, further comprising compiling a software framework based on the initial value.

11. A system comprising:
one or more processors performing the following steps:
receiving initiation input from a user regarding a type of software for development, wherein the software developed represents legal obligations, legal conditions and other legal specifications as a logical framework;
accessing an initial node of the logical framework based on the initiation input, wherein the initial node comprises one or more logical structures and links to one or more tables of states and values;
requesting at least one initial input to initiate the initial node;
receiving initial input from the user in response to the request;
accessing at least one of the one or more tables of states and values to determine if a calculation is required based on the initial input; and
performing, by one or more processors, a calculation based on the initial input from the user to determine an initial value or receiving, by one or more processors, an initial value from the at least one of the one or more tables of states and values

12. The system of claim 11, further comprising the steps of:
accessing a subsequent node of the logical framework in response to the initial value, wherein the subsequent node comprises one or more logical structures and links to tables of states and values;
providing at least one subsequent choice to the user regarding the subsequent node;
receiving subsequent input from the user in response to the at least one subsequent choice;
accessing tables of states and values to determine if a calculation is required; and
performing a calculation based on the subsequent input from the user to determine a subsequent value or receiving an subsequent value from a table of states and values.

13. The system of claim 12, further comprising the steps of:
repeating the steps from accessing a subsequent node to performing a calculation based on the subsequent input until there are no subsequent nodes in the tree hierarchy; and
compiling a software framework based on the calculations in each accessed node of the logical framework.

14. The system of claim 11, wherein one or more logical structures are if/then statements.

15. The system of claim 11, wherein the states are selected from the group consisting of: validity of a contract, execution of a contract, in compliance, out of compliance, reasons, responsibility, addresses of nodes, existence of elements, nonexistence of elements, and combinations thereof.

16. The system of claim 11, wherein the values are selected from the group consisting of: time, monetary amounts, rates, quantities, rankings, ratings, and combinations thereof.

17. The system of claim 11, wherein receiving a value from a table of states and values comprises determining an expiration date or time of a stored initial value.

18. The system of claim 11, further comprising compiling a software framework based on the initial value.

19. A system comprising:
one or more processors performing the following steps:
receiving initiation input from a user, wherein the initiation is an existing legal instrument adapted to be represented as a logical framework;
accessing an initial node of the logical framework based on the initiation input, wherein the initial node comprises one or more logical structures and links to one or more tables of states and values;
requesting at least one initial input to initiate the initial node;
receiving initial input from the user in response to the request;
accessing at least one of the one or more tables of states and values to determine if a calculation is required based on the initial input; and
performing, by one or more processors, a calculation based on the initial input from the user to determine an initial value or receiving, by one or more processors, an initial value from the at least one of the one or more tables of states and values

20. The system of claim 19, further comprising the steps of:
accessing a subsequent node of the logical framework in response to the initial value, wherein the subsequent node comprises one or more logical structures and links to tables of states and values;
providing at least one subsequent choice to the user regarding the subsequent node;
receiving subsequent input from the user in response to the at least one subsequent choice;
accessing tables of states and values to determine if a calculation is required;
performing a calculation based on the subsequent input from the user to determine a subsequent value or receiving an subsequent value from a table of states and values; and
repeating the steps from accessing a subsequent node to performing a calculation based on the subsequent input until there are no subsequent nodes in the tree hierarchy; and
compiling a software framework based on the calculations in each accessed node of the logical framework.
